(19) United States
(12) Patent Application Publication
(10) Pub. No.: US 2021/0382889 A1
(43) Pub. Date: Dec. 9, 2021

(54) INFORMATION PROCESSING APPARATUS

(71) Applicant: FUJIFILM Business Innovation Corp., Tokyo (JP)

(72) Inventors: Shotaro MISAWA, Kanagawa (JP); Tomoko OKUMA, Kanagawa (JP)

(73) Assignee: FUJIFILM Business Innovation Corp., Tokyo (JP)

(21) Appl. No.: 17/037,744

(22) Filed: Sep. 30, 2020

(30) Foreign Application Priority Data
Jun. 5, 2020 (JP) 2020-098318

(51) Int. Cl. G06F 16/2453; G06F 16/248

(52) U.S. Cl. CPC G06F 16/2454; G06F 16/248

(57) ABSTRACT

An information processing apparatus includes a processor configured to receive a narrowing condition designated upon a search request of a content, create a sentence which uses a more detailed expression of an expression described in the narrowing condition and indicates details of the content or select the sentence from sentence candidates prepared in advance, and present the created or selected sentence as a search result of the content.

### CROSS-REFERENCE TO RELATED APPLICATIONS

This application is based on and claims priority under 35 USC 119 from Japanese Patent Application No. 2020-098318 filed Jun. 5, 2020.

### BACKGROUND

### (i) Technical Field

The present invention relates to an information processing apparatus.

### (ii) Related Art

For example, a company that mediates a job change extracts a company corresponding to narrowing conditions input by a user on a job change site, from multiple companies that are recruiting human resources, and provides recruitment information of the extracted company for the user. The user refers to the recruitment information of each company displayed on a screen to search for a company to be changed to.

### SUMMARY

In a case where the user designates the narrowing condition to search for the content, for example, in a case where the user searches for the content by designating “sales job” as the narrowing condition on the job change site, even though a result saying “recruiting a sales job” is displayed in a title indicating the details of the provided content, information indicating the sales job is naturally provided because the user designates the narrowing condition of “sales job” and performs searching. That is, the semantic range indicated by the word “sales job” does not change by the narrowing condition and the title, and thus it is difficult to present particularly new information to the user.

Aspects of non-limiting embodiments of the present disclosure relate to an information processing apparatus that provides details of a content which is more detailed than a case where details of a content expressed by a semantic range itself indicated by a word indicating a narrowing condition are provided for a user, in a case where the user designates the narrowing condition to search for the content.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive a narrowing condition designated upon a search request of a content, create a sentence which uses a more detailed expression of an expression described in the narrowing condition and indicates details of the content or select the sentence from sentence candidates prepared in advance, and present the created or selected sentence as a search result of the content.

### BRIEF DESCRIPTION OF THE DRAWINGS

Exemplary embodiment(s) of the present invention will be described in detail based on the following figures, wherein:

FIG. 1 is an overall configuration diagram illustrating a network system according to a first exemplary embodiment;

FIG. 2 is a diagram illustrating a screen display example of a job change site in the first exemplary embodiment;

FIG. 3 is a flowchart illustrating title presentation processing in the first exemplary embodiment;

FIG. 4 is an overall configuration diagram illustrating a network system according to a second exemplary embodiment; and

FIG. 5 is an overall configuration diagram illustrating a network system according to a third exemplary embodiment.

### DETAILED DESCRIPTION

Hereinafter, exemplary embodiments of the present invention will be described with reference to the drawings. In the present exemplary embodiment, recruitment information provided by a job change service company that mediates job change will be described as an example of a content provided for a user.

### First Exemplary Embodiment

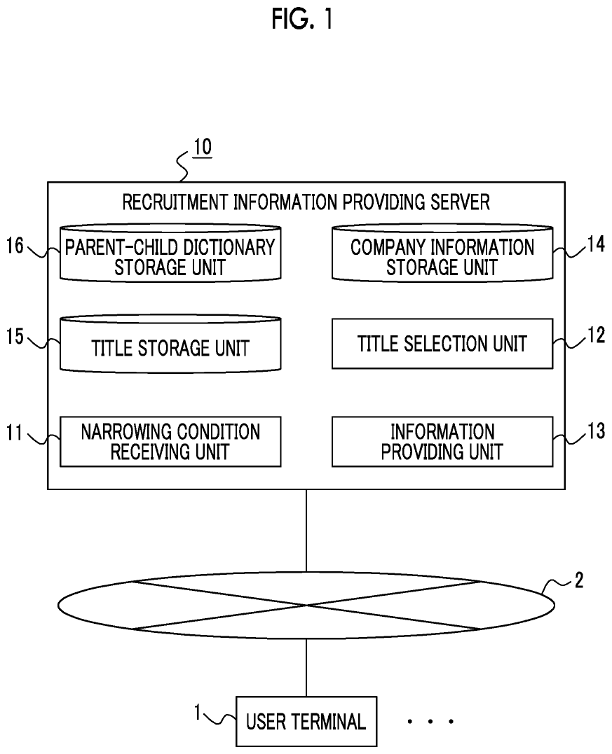

FIG. 1 is an overall configuration diagram illustrating a network system capable of using a job change site in the present exemplary embodiment. The job change site is a website operated by a job change service company in order to provide recruitment information for users who want to change jobs. FIG. 1 illustrates a configuration in which a recruitment information providing server 10 and a user terminal 1 are connected to each other by a network 2 such as the Internet. The recruitment information providing server 10 is a server computer owned by the job change service company. The user terminal 1 is an information processing apparatus such as a personal computer (PC) or a smartphone, which is normally used by a user and has a communication function capable of accessing the network. The user terminal 1 is a terminal used by a user who wants to find a job change destination by using the job change site provided by the job change service company using the recruitment information providing server 10. The recruitment information providing server 10 is accessed from a plurality of user terminals 1. In the present exemplary embodiment, the functions of the user terminals 1 may be identical to each other. Thus, FIG. 1 illustrates only one user terminal.

The recruitment information providing server 10 may be realized by a hardware configuration of a general-purpose server computer which has been provided in the past. That is, the recruitment information providing server 10 includes a processor, a ROM, a RAM, a storage unit such as a hard disk drive (HDD), and a network interface (IF) for communicating with the user terminal 1 via the network 2. The recruitment information providing server 10 may include a user interface including an input unit such as a mouse and a keyboard and a display unit such as a display, as necessary.

FIG. 1 illustrates a block configuration of the recruitment information providing server 10. The recruitment information providing server 10 according to the present exemplary embodiment includes a narrowing condition receiving unit 11, a title selection unit 12, an information providing unit 13, a company information storage unit 14, a title storage unit 15, and a parent-child dictionary storage unit 16. The components which are not used in the description of the present exemplary embodiment will be omitted in FIG. 1.

The narrowing condition receiving unit 11 receives the narrowing condition designated by the user from the job change site. The title selection unit 12 selects a title to be presented to the user, for each company, from title candidates registered in the title storage unit 15 based on the received narrowing condition. The information providing unit 13 presents, to the user, the title of each company, which is selected by the title selection unit 12 by displaying the selected title on the job change site.

Company information regarding a company that requests the job change service company to perform recruitment is accumulated in the company information storage unit 14. The company information includes company information such as an overview and the location of the company, and recruitment information such as personnel required by the company, the type of occupation, treatment, and hiring conditions. The company information may be described in sentences or bullet points, or necessary items may be described in a table format.

In response to a request from the user, the recruitment information providing server 10 provides the user with recruitment information of a company that matches the narrowing condition designated by the user. However, the recruitment information providing server 10 provides a title which briefly represents details of the recruitment information of the company before providing the recruitment information. Candidates for the title to be presented to the user are created in advance for each company, and are registered in the title storage unit 15.

A parent-child dictionary is registered in the parent-child dictionary storage unit 16. In the parent-child dictionary, one or a plurality of phrases positioned as child phrases of a parent phrase are registered to correspond to the parent phrase.

The components 11 to 13 of the recruitment information providing server 10 are realized by a cooperative operation of a computer forming the recruitment information providing server 10 and a program operating on a processor mounted in the computer. The storage units 14 to 16 are realized by an HDD mounted in the recruitment information providing server 10. Alternatively, the RAM or an external storage unit may be used via the network.

The program used in the present exemplary embodiment may be provided not only by a communication unit but also by being stored in a computer-readable recording medium such as a CD-ROM or a USB memory. The program provided from a communication unit or a recording medium is installed on the computer, and the CPU of the computer sequentially executes the program to realize various types of processing.

A job change service company generally opens a job change site and provides recruitment information to a user who wants a job change via a network. The job change site provides information on various companies that are recruiting. A search screen is generally prepared in the job change site. A user designates a narrowing condition such as a required type of occupation or a required work location, from the search screen to narrow down the required company from companies which are recruiting. For example, in a case where the user searches a sales job, the user inputs a keyword such as “sales job” as a narrowing condition.

The job change service company presents, to the user, the title as the recruitment information regarding the company that matches the narrowing condition. The title is a short sentence that briefly represents the characteristics of the details of the recruitment information in the company. In a case where the user refers to the title and determines that the company is interested, for example, the user clicks the title to display the detailed recruitment information of the company on a screen.

For example, even though the job change service company provides the user with the title of “a sales job is being recruited.” as information regarding a company A that recruits a sales job, it is not possible for the user to obtain new information regarding the A company from the information. In other words, just by simply providing information that the company A is recruiting sales jobs in response to the request from the user, that is, the narrowing condition designated by the user, the job change service company does not provide useful information for the user who intends to apply for the sales job. For example, because the user wants a sales job, it is considered that the user expects to obtain deep information such as attraction of new customer, retention sales, or a work location, for the designated narrowing condition from the job change site.

Thus, in the present exemplary embodiment, it is possible to present a title using a more detailed expression of an expression described in a narrowing condition designated by a user.

“Deep digging” is defined as making something more clear. “Deep digging” in the present exemplary embodiment means that information that is one step closer to the narrowing condition, in other words, more limited, more specific, more detailed information, or information regarding a category different from the narrowing condition is included.

More specifically, in a case where the user designates a word “sales” in a narrowing condition, the narrowing condition means that the user searches for a sales job. Presenting a title “sales job is being recruited” to the user for the narrowing condition means that the title is presented in a range in which a semantic itself indicated by the word “sales” designated in the narrowing condition remains unchanged. On the other hand, for example, a title “I am searching for attracting a new customer” presents, to the user, more detailed information in that this is a business for attracting a new customer even in the sales job. In the present exemplary embodiment, it is possible to present a title including more detailed information instead of presenting the title in the semantic range itself indicated by the word “sales” as described above.

Next, an operation of the present exemplary embodiment will be described. In the present exemplary embodiment, a title for a company that matches a narrowing condition is presented in response to the narrowing condition designated by the user.

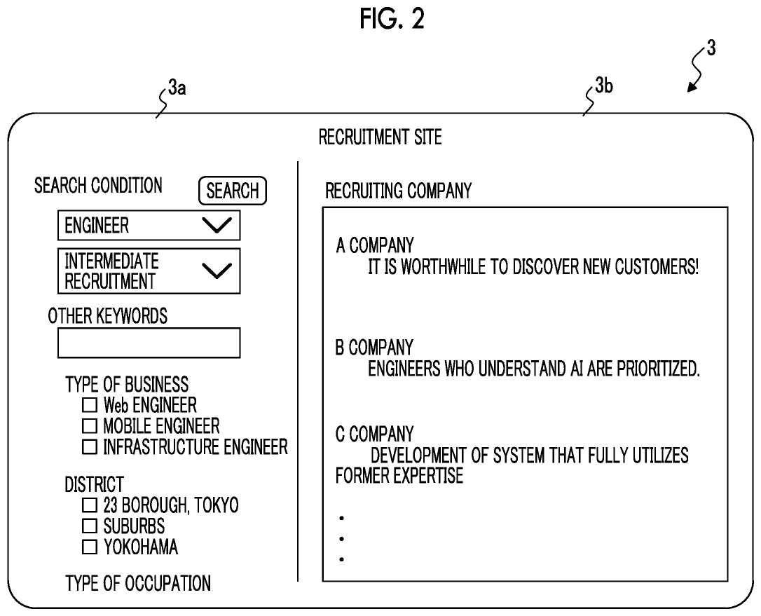

FIG. 2 is a diagram illustrating an example of screen display of the job change site provided by the job change service company in the present exemplary embodiment. A job change site 3 is displayed in the user terminal 1 by a browser installed on the user terminal 1. A display screen 2 (referred to as a “job change site” below) of the job change site includes regions being a condition setting region 3a and a search result display region 3b. In the condition setting region 3a, the user designates a narrowing condition for narrowing down companies among companies that are recruiting. In the search result display region 3b, a list of information regarding a company that matches the narrowing condition designated in the condition setting region 3a is displayed. Since the company that matches the narrowing condition is extracted by searching the company information storage unit 14, the narrowing condition and a search condition are used synonymously in the present exemplary embodiment. In the search result display region 3b, at least a title of each company that matches the designated narrowing condition is displayed.

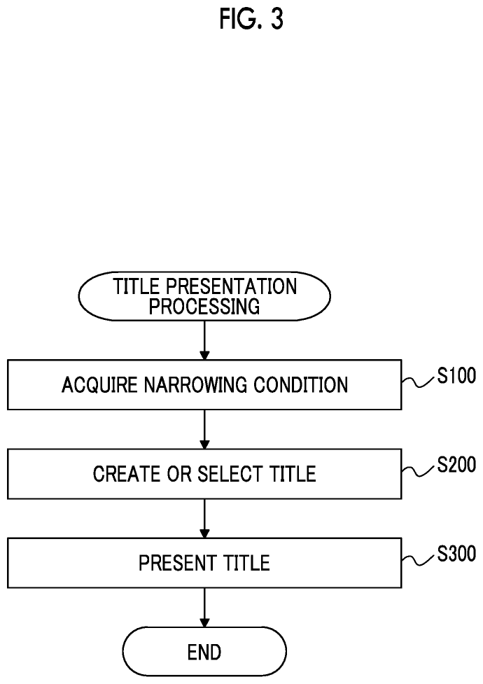

Title presentation processing in the present exemplary embodiment will be described below with reference to the flowchart illustrated in FIG. 3.

In a case where the user designates a narrowing condition by manually inputting a keyword in a keyword input field or checking a check box of a field (generally referred to as a “category”) to be searched, from the condition setting region 3a, the narrowing condition receiving unit 11 receives the designated narrowing condition (Step S100). Here, for simple description, it is assumed that the user has designated the keyword “sales” as the narrowing condition.

The title selection unit 12 selects a company that matches the narrowing condition by searching the company information storage unit 14. The title selection unit 12 selects, for each selected company, a title to be presented to the user from candidates for a title of the company, which are registered in the title storage unit 15 by referring to the narrowing condition (Step S200).

For example, it is assumed that, in a case where a company

A corresponds to the narrowing condition of “sales”, the following three title candidates 1 to 3 corresponding to the company A are registered in the title storage unit 15.

Candidate 1: Recruiting sales experts

Candidate 2: It is worthwhile to discover new customers!

Candidate 3: Someone who will do retention sales!

The title selection unit 12 selects a title to be presented to the user from the title candidates 1 to 3 with reference to the expression described in the narrowing condition, for example, in a manner as follows.

For the candidates 1 and 3 among the three title candidates 1 to 3, narrowing conditions are designated by the expression “sales” in order to narrow down the company required by the user. That is, even though the expression “sales” is simply included in a case where the user obtains recruitment information of each company, the user may not be provided with any new information.

Thus, the title selection unit 12 does not select the candidates 1 and 3 including the word “sales” designated in the narrowing condition, but selects the candidate 2 having a high possibility of more detailed information because the “sales” is not included, as the title to be provided for the user. The information providing unit 13 presents the title candidate 2 selected by the title selection unit 12 to the user, by displaying the title candidate 2 on the job change site 3 as the title of the company A (Step S300).

As described above, according to the present exemplary embodiment, it is possible to present, to the user, a title that does not include the expression “sales” designated by the user in the narrowing condition, as the recruitment information for the company A. In addition, in a case where a category indicating the type of occupation of “sales” is designated in the narrowing condition by performing such processing, it is easy to select a title including a phrase of a category other than the category indicating “sales”, for example, a category such as a work location, which is different from the type of occupation. Thus, it is possible to present a title including more information than the user expects.

Alternatively, the title to be presented to the user may be selected in a manner as follows.

In the above example, the candidates 1 and 3 including the word “sales” designated in the narrowing condition are not selected. However, “retention sales” included in the candidate 3 of the candidates 1 and 3 is a compound word including “sales”. That is, it is considered that “retention sales” is a word in which “sales” is further detailed. In practice, “retention sales” is a phrase that limits the job category of sales.

Thus, the title selection unit 12 may select the candidate 3 of the title including the compound word in a case where the word “sales” designated in the narrowing condition is included, but the word is a compound word.

In addition, in a case where title candidates including child phrases corresponding to a parent phrase of “sales” are provided by referring to the parent-child dictionary illustrated in FIG. 1, the title selection unit 12 may select the title candidate including the child phrase.

For example, in a case where “sales” is registered as a parent phrase in the parent-child dictionary, and “sales” corresponds to child phrases such as “retention sales” and “corporate sales”, the title selection unit selects the title candidate including the child phrase such as “retention sales” or “corporate sales”.

The child phrase registered in the parent-child dictionary is not necessarily limited to a compound word. For example, in a case where “programmer” is registered as a parent phrase in the parent-child dictionary, a phrase such as “C language” and “Web development”, which is not a compound word, may be registered as a child phrase of “programmer”.

### Second Exemplary Embodiment

In the above-described first exemplary embodiment, a case where the title candidates of each company are created in advance and registered in the title storage unit 15 has been described. In the present exemplary embodiment, creation of title candidates of each company will be described.

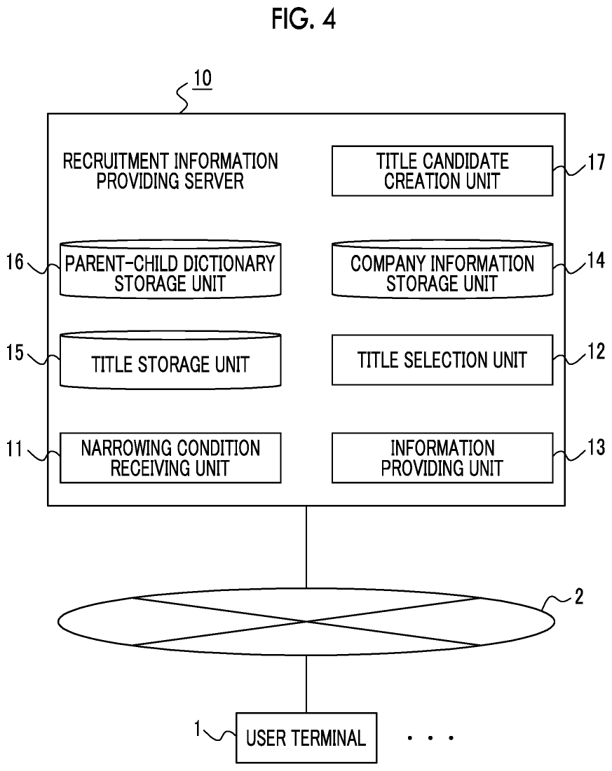

FIG. 4 is an overall configuration diagram illustrating a network system that may use a job change site in the present exemplary embodiment, and is a diagram corresponding to FIG. 1 in the first exemplary embodiment. In FIG. 4, the identical components as the components in FIG. 1 are designated by the identical reference signs, and the description thereof will be omitted. A recruitment information providing server 10 in the present exemplary embodiment has a configuration in which a title candidate creation unit 17 is added to the configuration illustrated in FIG. 1. The title candidate creation unit 17 creates title candidates of each company with a learning model. The title candidate creation unit 17 is realized by a cooperative operation of a computer forming the recruitment information providing server 10 and a program operating on a processor mounted in the computer.

In the present exemplary embodiment, the title candidate creation unit 17 creates title candidates using a relevance estimation model. The relevance estimation model is a model learned to output a relevance between the content corresponding to the input content information and the input sentence by inputting content information including details of a content as a narrowing target by a narrowing condition, a sentence explaining the details of the content, and flag information indicating whether or not the sentence is associated with the content. The content here is recruitment information as described above. The content information including the details of the content is the company information registered in the company information storage unit 14. The sentence corresponds to the title. The narrowing condition itself may be used for the input instead of the sentence.

For example, in a case where title candidates of the company A are created, the title candidate creation unit 17 acquires a plurality of types of titles adopted by the company A in the past. The title candidate creation unit 17 causes the relevance estimation model to perform learning by inputting a set including the company information of the company A, any one title which has been adopted in the past, flag information indicating that the title is a title of company A, and “1” indicating a correct combination here. The title input to the relevance estimation model here may be a title adopted at the job change site in practice.

The title candidate creation unit 17 causes the relevance estimation model to perform learning by inputting a set including the company information of the company A, the titles adopted by other companies, the flag information indicating that the title is not the title of the company A, and “0” indicating an incorrect combination here. In this manner, the relevance estimation model is formed. Although the company A has been described here, the relevance estimation model is caused to learn each of the companies B and C by inputting information in the similar manner.

The title candidate creation unit 17 inputs the company information of the company A and the title candidate of the company A into the relevance estimation model, and outputs the relevance. The title candidate of the company A, which is input to the relevance estimation model is not necessarily limited. Examples of the title candidate include a title which has been adopted in the past, a new-created title, and the like. The new-created title may be created by a title creation model described in a third exemplary embodiment.

In this manner, in a case where the relevance is obtained for each title candidate, the title candidate creation unit 17 registers the title candidate having a relevance which is equal to or greater than a predetermined threshold value, in the title storage unit 15. Alternatively, the title candidate creation unit 17 may register n (n is a natural number) title candidates having a high relevance, in the title storage unit 15. At this time, for example, a registration condition such as a title including a compound word may be set as the title registered in the title storage unit 15.

In the present exemplary embodiment, in forming the relevance estimation model for the company A, learning is performed using correct answer data consisting of a set including the company information of the company A and the title of the company A, and incorrect answer data consisting of a set including the company information of the company A and a title of a company other than the company A. Thus, it is easy to generate a title that enable the A company to be distinguished from other companies. The relevance output by the relevance estimation model is an index indicating the degree of relevancy between the company information and the title which are input, and may be an index for determining whether the title is proper or improper.

Although the case where the title candidate to be registered in the title storage unit 15 is created has been described as an example here, the title to be presented to the user may be selected instead of the title selection unit 12, for example. That is, the title candidate creation unit 17 may select the title candidate having the maximum relevance as the title to be presented to the user, as the search result for the narrowing condition.

It is considered that the title (set as a “title T1” here) which has the maximum relevance and is output from the relevance estimation model is the optimum title for the company A, but other cases may be provided. For example, it is assumed that the relevance may take a value of 0 to 1. Here, it is assumed that the relevance output from the relevance estimation model in a case where the company information of the company A and the title T1 are input is 0.9. Basically, since the relevance is large, the title T1 has a high possibility of being adopted as the title of company A. It is assumed that the output relevance when the company information of the company B different from the company A and the candidate for the title T1 are input is 0.8. In this case, the difference in relevance between the company A and the company B is 0.1. That is, the title T1 may be a title showing the characteristics of the company B, and is not a title showing the uniqueness of the company A.

Meanwhile, it is assumed that a certain title (set as a “title T2” below) has a relevance of 0.5. Here, it is assumed that the relevance when the company information of the company B and the title T2 are input is 0.1. That is, regarding the title T2, the difference in relevance between the company A and the company B is 0.4. That is, in a case where the titles T1 and T2 are compared to each other, the title T2 is more unique and appropriate for the company A because the title T2 has a larger difference in relevance with the company B. Therefore, the title having the maximum relevance is not necessarily selected, and a title having a large difference in relevance with another company, specifically, a title having a difference in relevance with another company, which is equal to or greater than a predetermined threshold value, may be selected. The above description will be described in more detail.

For example, the followings are assumed. In a finished vehicle manufacturer of a vehicle (here, company A),

Title T1: “Let's make the next-generation car!”

Title T2: “I can take on the design work”

Two candidates (for the relevance, T1>T2) as described above are provided. In the subcontractor manufacturer of the company A (here, company B),

Title T3: “Let's work at a car-related company!”

Title T4: “Let's support manufacturing from production management!”

Two candidates as described above are provided. Here, in a case where “car-related” is designated as the narrowing condition, even though the company A is focusing on electric vehicles and the degree of conformity is high, the company A is applicable to the subcontracting company B to some extent. In a case of being viewed as the whole of the companies registered in the company information storage unit 14, the title T1 may be more relevant to the company A, but the title T2 is more unique when viewed in the search results. In such a case, the title T2 is selected.

In the above example, the case where only company B appears as another company has been described, but a plurality of other companies may be provided. In this case, the relevance in another company may be determined by a predetermined calculation method based on, for example, the relevance in each company, for example, by obtaining the average value of the relevance in the companies.

### Third Exemplary Embodiment

In the above-described exemplary embodiments, the title to be presented to the user is selected from a plurality of candidates and then presented. In the present exemplary embodiment, a title to be presented to the user is created.

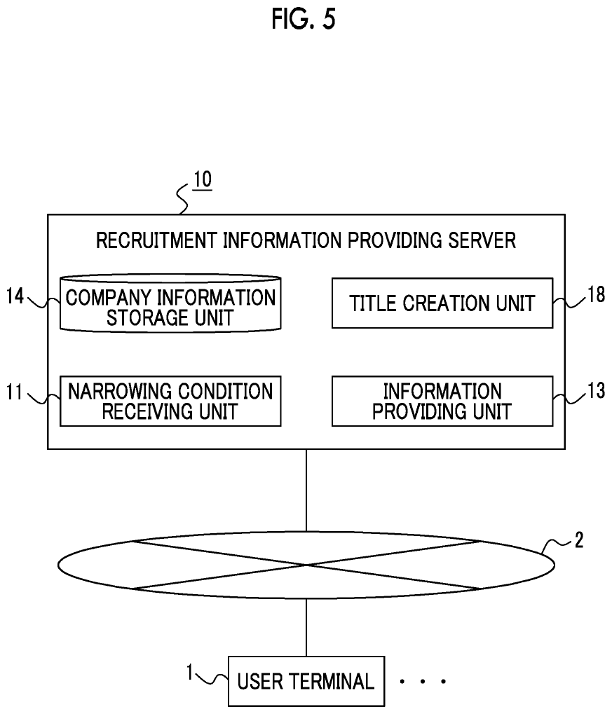

FIG. 5 is an overall configuration diagram illustrating a network system that may use a job change site in the present exemplary embodiment, and is a diagram corresponding to FIG. 1 in the first exemplary embodiment. In FIG. 5, the identical components as the components in FIG. 1 are designated by the identical reference signs, and the description thereof will be omitted. In the present exemplary embodiment, a recruitment information providing server 10 has a configuration in which a title creation unit 18 is added to the narrowing condition receiving unit 11, the information providing unit 13, and the company information storage unit 14 illustrated in FIG. 1. The title creation unit 18 creates a title of each company to be presented to the user by using a learning model. The title creation unit 18 is realized by a cooperative operation of a computer forming the recruitment information providing server 10 and a program operating on a processor mounted in the computer. In the present exemplary embodiment, title presentation processing may correspond to the processing flow illustrated in FIG. 3.

The title creation unit 18 uses an encoder/decoder model as a learning model for generating a title. The learning model (referred to as a “title creation model” below) realized by the encoder/decoder model is a model learned to output a title by inputting company information of a company.

In the present exemplary embodiment, according to the example described in the first exemplary embodiment, in a case where the expression “sales” is included in a narrowing condition, the title creation model is formed such that “sales” is not selected as the phrase included in a title or is hard to be selected, and further it is easy to select a compound word such as “retention sales”. Alternatively, by inputting a weighting instruction for “sales” to the title creation model, title creation control may be performed such that a title that does not include the expression “sales” itself is created.

The learning of the title creation model will be described below.

The title creation model is a model learned by inputting the company information and an expression (“sales” in the above example) designated in the narrowing condition and outputting a title described below as a correct answer, as a title corresponding to the input company.

For example, in the company A, three types of titles corresponding to the narrowing condition (for example, “sales”) are practically opened to the public individually on the job change site and presented to the user. When each of the three types of titles is displayed, the user performs a predetermined operation on the job change site 3 to acquire the record value of the number of clicks (or click rate) when the recruitment information of the company A is displayed. The click rate is a proportion of the number of clicks of each title to the total number of clicks of the titles. As the click rate increases, the number of times of being selected by the user among all the titles increases. For example, the three types of titles and the number of clicks of the titles are shown below.

Title 1: Recruiting Sales Experts

Clicks: 10

Title 2: It is worthwhile to discover new customers!

Clicks: 80

Title 3: Someone who will do retention sales!

Clicks: 70

The title creation model is learned by adopting any one of the following three patterns based on the selection record of the title by the user as described above, that is, based on the click rate.

In a pattern 1, learning is performed to output a title having a click rate which is the maximum and is equal to or greater than a threshold value. For example, in a case where the company information of the company A and “sales” as the narrowing condition are input, learning is performed to output a title in which the number of clicks is the maximum and the click rate to the total number of clicks (10+80+70=160) is equal to or greater than a predetermined threshold value (for example, 50%). In the example of the above title, in a case where the company information of the company A and “sales” as the narrowing condition are input, learning is performed to output the title 2 as the correct answer.

In the pattern 2, learning is performed by inputting the company information, the narrowing condition (“sales” in the above example), and a learning rate. The learning rate is a parameter used for learning of the title creation model, and the click rate is used here. For example, regarding the title 1, in a case where the company information, “sales” as the narrowing condition, and 10/160 as the learning rate are input, a new learning rate is obtained by multiplying the known learning rate (for example, 0.1) by the input 10/160 (0.1*(10/160)). Then, the title creation model is updated.

In the pattern 3, a new learning model is used. That is, a learning model (referred to as a “click rate estimation model” below) in which a title is input and a click rate is output is used. The above-described record data of the number of clicks is used for learning of the click rate estimation model. That is, in a case where the title 1 is input, the click rate estimation model is learned to output 10/160 as the correct answer. In a case where the title 2 is input, the click rate estimation model is learned to output 80/160 as the correct answer. Similarly, in a case where the title 3 is input, the click rate estimation model is learned to output 70/160 as the correct answer. Then, the pattern 1 and the pattern 2 are performed using a set including the title input to the click rate estimation model and the click rate output by the click rate estimation model. In the patterns 1 and 2, the title creation model is learned by using the title for which the click rate is obtained as the record value. However, in the pattern 3, since it is possible to obtain the click rate for the title by estimation even though the title does not have the click rate as the record value, the title may be presented as the title of the company A. In a case where the title creation model is learned without applying the patterns 1 and 2, a reinforcement learning generation model in which the output of the click estimation model is used as the reward may be used.

In a case where the company information is input, the title creation unit 18 creates a title using the title creation model formed as described above (Step S200). The information providing unit 13 presents the title created by the title creation unit 18 to the user, by displaying the title on the job change site 3 as the title of the company A (Step S300). The title displayed on the job change site may be changed by a new title created by the title creation unit 18 based on the selection record of the user.

### MODIFICATION EXAMPLES

In the above-described exemplary embodiments, the title using a more detailed expression of the expression described in the narrowing condition, that is, the title in which the narrowing condition is deeply dug is presented to the user. Specifically, in a case where the expression described in the narrowing condition is “sales”, the title which does not include the expression “sales”, the title expressed by a compound word such as “retention sales” even though the expression “sales” is included, or the like is presented.

However, a case where the title using a more detailed expression of the expression described in the narrowing condition is not provided among the title candidates or it is not possible to create the title is also considered. In this case, a title including details of the content related to a category other than the category to which the expression described in the narrowing condition belongs may be presented. For example, in a case where a user is searching for a job as a foreign language teacher and designates “French” as a narrowing condition, and it is not possible to present a title using a more detailed expression of “French”, a title including information regarding working conditions such as the required skill level in French, the work location, and the treatment in addition to the category related to the language such as French, English, and Chinese may be presented. In this manner, it is possible to provide information that goes one step further for the narrowing conditions.

In a case where the user designates a plurality of phrases of the identical category in the narrowing condition, the narrowing condition may not be dug deeply. For example, in a case where the user is searching for a job as a foreign language teacher and designates English and French as the narrowing conditions, it is considered that, for example, a title of “there are not enough people who can speak English and French” is more useful information for the user than a title of “urgent recruitment of someone who can speak English and Chinese, French, or Italian” and a title dug up to other languages. In this manner, in a case where a plurality of narrowing conditions are designated for one category of language, a title which is deliberately dug into that category may not be created.

In a case where the user designates different categories as the narrowing condition, basically, the above-described processing may be performed for each expression designated by each category. Specifically, the narrowing condition is dug deep in both multiple categories. Alternatively, only one may be the target of deep digging. As the category as a target of deep digging, a past result, that is, a category having a high click rate due to deep digging may be selected, and an expression corresponding to the category may be deeply dug. Alternatively, the categories may be given priorities in advance, and expressions corresponding to the high-priority categories may be dug deeply.

In the present exemplary embodiment, a title expressed in the semantic range itself indicated by the word indicating the narrowing condition is not presented to the user, but a more detailed title is presented. It is possible to present more useful information to the user by performing processing in this manner. However, even for a more detailed title, in a case where the user does not intend to refer to the recruitment information of the company of the title, that is, in a case where the click rate does not increase, the detailed title may have a problem. Therefore, the detailed title may not be adopted. Specifically, record information about the number of clicks of each presented title is acquired. In a case where the user does not show an interest even though the detailed title is presented and the click rate does not increase from before, the detailed title is not adopted. In this case, the title may be restored to the original. For example, the title may be changed to a title including a child word or compound word different from the presented title, or may be changed to a title including a phrase belonging to another category.

The number of clicks may be obtained for each title presented as the record information as described above, and a title having a high click rate may be normally selected and presented to the user.

In the above-described exemplary embodiments, the case where the present disclosure is applied to the job change service that mediates a job change has been described as an example. The present disclosure may be applied to general systems that search for contents using other narrowing conditions.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
receive a narrowing condition designated upon a search request of a content,
create a sentence which uses a more detailed expression of an expression described in the narrowing condition and indicates details of the content or select the sentence from sentence candidates prepared in advance, and
present the created or selected sentence as a search result of the content.

2. The information processing apparatus according to claim 1, wherein
the detailed expression includes a compound word including the expression described in the narrowing condition.

3. The information processing apparatus according to claim 1, wherein
the processor is configured to, in a case where a sentence using a more detailed expression of an expression described in the narrowing condition is not provided or creation of the sentence is not possible, present a sentence including details of the content related to a category other than a category to which the expression belongs.

4. The information processing apparatus according to claim 2, wherein
the processor is configured to, in a case where a sentence using a more detailed expression of an expression described in the narrowing condition is not provided or creation of the sentence is not possible, present a sentence including details of the content related to a category other than a category to which the expression belongs.

5. The information processing apparatus according to claim 1, wherein
the processor is configured to determine whether to use or change the presented sentence based on a record in which the presented sentence has been selected.

6. The information processing apparatus according to claim 5, wherein
the processor is configured to
present each of a plurality of sentences as a search result of the content, and
present the sentence of which the number of selections is largest among the plurality of the presented sentences, as the search result of the content when a narrowing condition including the expression described in the narrowing condition is received.

7. The information processing apparatus according to claim 1, wherein
the processor is configured to
use, as inputs, content information including details of a content as a narrowing target by the narrowing condition, a sentence explaining details of the content, and information indicating whether or not the sentence is associated with the content, and input a plurality of sets including the content information and sentence candidates for the sentence explaining the details of the content, to a relevance estimation model which is learned to output a relevance between the content corresponding to the input content information and the input sentence, and
present the sentence candidate having a highest relevance among the plurality of the input sentence candidates, as a search result of the content.

8. The information processing apparatus according to claim 7, wherein
the processor is configured to
acquire a first relevance by inputting, to the relevance estimation model, the set including the content information including the details of the content as the narrowing target by the narrowing condition and the sentence explaining the details of the content as the narrowing target by the narrowing condition,
acquire a second relevance by inputting, to the relevance estimation model, a set including content information including details of a content other than the content as the narrowing target by the narrowing condition and the sentence explaining the details of the content as the narrowing target by the narrowing condition, and
not to present the sentence to a user in a case where there is no predetermined difference between the acquired first relevance and the acquired second relevance.
